(19) United States
(12) Patent Application Publication
(10) Pub. No.: US 2012/0121876 A1
(43) Pub. Date: May 17, 2012

(54) Elastomeric Composition

(76) Inventor: Daniel Milesi, Voiron (FR)

(21) Appl. No.: 13/141,506

(22) PCT Filed: Dec. 23, 2009
(86) PCT No.: PCT/EP2009/067857

§ 371 Date: Nov. 29, 2011

(30) Foreign Application Priority Data
Dec. 23, 2008 (EP) 08306011.1

(51) Int. Cl. C08L 53/00; C08K 7/22; C08K 3/36

(52) U.S. Cl. 428/220; 525/93; 524/505; 524/269; 521/139

(57) ABSTRACT

Use of a material for the absorption of impact energy wherein the composition of the material is a mixture of, at least component (A) which is an organic thermoplastic elastomer having a hardness below 80 shore A measured at 23° C. and component (B) which is a non cross-linked and substantially non reactive silicone polymer or a cross-linked silicone polymer, with the exclusion of borated silicone polymers exhibiting dilatant properties.

This invention relates to the new use of an elastomeric composition as an energy-absorbing material in order to provide impact resistance. The invention also concerns different impact protection articles made, at least, in part with such a composition.

The presently available impact-protection materials tend to fall into two categories, namely a rigid exterior shell which can be uncomfortable to wear (e.g. knee or elbow protectors) or foam pads (e.g. inserts for clothing) which provide poor levels of protection. Energy-absorbing materials have therefore been proposed which combine the protection of rigid shells and the flexibility of foam pads.

Energy-absorbing materials find wide application, for example in protective garments for potentially dangerous sports such as motorcycling, skiing, skating, skateboarding or snowboarding, and as protective packaging materials. Typically, energy-absorbing materials are formed into sheets, which may then be further processed into shaped articles formed partially or completely from the sheet material. The sheet material may be formed from energy-absorbing material per se, or the sheet may be formed from substrate, such as a fabric or a foam impregnated with the energy-absorbing material. In most of the known solutions, a dilatant material is part of the product.

By the way of an example, WO 03/022085 describes a flexible energy absorbing material in which a dilatant (shear thickening) material is impregnated into a flexible carrier such as a fabric or foam. The dilatant material remains soft until it is subjected to an impact, when its characteristics change rendering it temporarily rigid. The dilatant material returns to its normal flexible state after the impact. The preferred dilatant material is a silicone composition available from Dow Corning under the trade mark “Dow Corning® 3179”. The flexible energy absorbing material may be worn as impact protection, for example as clothing or as knee or elbow pads.

WO 05/000966 describes an other solution with a dilatant material in the form of an elastic composite which exhibits a resistive load under deformation which increases with the rate of deformation, which is unfoamed or foamed, comminuted or uncomminuted and which comprises i) a first polymer based elastic material and ii) a second polymer bases material different from i) which exhibits dilatancy in the absence of i) wherein ii) is entrapped in a solid matrix of i) the composite material being unfoamed or, when foamed preparable by incorporating ii) with i) prior to foaming.

Another field of energy absorption is vibration dampening in which organic thermoplastic elastomer (TPE) are used. By the way of an example, EP 0 362 850 B1, relates to a new block copolymer having excellent damping vibration properties. The block copolymer has a numerical average molecular weight of 30,000 to 300,000 and is composed of two or more blocks consisting of aromatic vinyl units having a numerical average molecular weight of 2500 to 40,000, and of one or more blocks containing a vinyl bonding content of not less than 40%, having a peak temperature of primary dispersion of tan delta at least 0° C., and consisting of isoprene or isoprene-butadiene units in which at least a part of carbon-carbon double bonds may be hydrogenated. The block copolymers can be processed in hot melt state and easily moulded. GB2353286 describes a mouthguard composition which comprises 40 to 80% by weight of a styrene block copolymer, from 20 to 60% by weight of an alicyclic saturated hydrocarbon resin and from 0.1 to 10% by weight of an organopolysilane. US2003/0109623 describes a re-processable thermoplastic elastomer composition comprising a thermoplastic polyurethane polymer and a silicone elastomer in a weight ratio of from 5:95 to 85:15.

EP 1 408 076 A1 provides an other solution in the form of a thermoplastic elastomer composition which is not only satisfactory in rubber-like characteristics and mouldability but also satisfactory in both permanent compression set and vibration damping properties and comprises an unsaturated bond-containing isobutylene polymer (A) and an olefinic resin (B).

However, there remains a need in the art for flexible energy-absorbing materials which can absorb greater amounts of energy without compromising flexibility.

Accordingly, the present invention concerns the use of a material for the absorption of impact energy wherein the composition of the material is a mixture of, at least:
a. component (A) an organic thermoplastic elastomer having a hardness below 80 shore A measured at 23° C. (ISO 868)
b. component (B) which is a non reactive and non cross-linked silicone polymer or a cross-linked silicone polymer, with the exclusion of borated silicone polymers exhibiting dilatant properties.

The use of such a combination of components provides an excellent balance of flexibility and energy-absorption.

Another aspect of the invention concerns the new compositions used according to the invention.

So, in accordance with another aspect of this invention, there is provided a composition which exhibits impact energy absorption in which component (A) an organic thermoplastic elastomer having a hardness below 80 shore A measured at 23° C. (ISO 868), which is, preferably, a block copolymer having a numerical molecular weight between 30000 g/mol and 500000 g/mol composed of 2 or more hard blocks of aromatic vinyl units having a numerical molecular weight between 2000 g/mol and 70000 g/mol, and one or more unsaturated, partially saturated or fully saturated aliphatic soft blocks.

In one embodiment there is provided a composition which exhibits impact energy absorption in which component (A) an organic thermoplastic elastomer having a hardness below 80 shore A measured at 23° C. (ISO 868), which is, preferably, a block copolymer having a numerical molecular weight between 30000 g/mol and 500000 g/mol composed of 2 or more hard blocks of aromatic vinyl units having a numerical molecular weight between 2000 g/mol and 70000 g/mol, and one or more unsaturated, partially saturated or fully saturated aliphatic soft blocks and component (B) is as hereinbefore described. Optionally component (B) is a cross linked silicone polymer.

In accordance with another aspect of this invention, there is provided another composition which exhibits impact energy absorption which is a mixture of:
a. component (A) an organic thermoplastic elastomer having a hardness below 80 shore A measured at 23° C. (ISO 868),
b. component (B) which is a non cross linked and non reactive silicone polymer, with the exclusion of borated silicone polymers exhibiting dilatant properties.

The invention also concerned all the use and compositions as described in the claims.

### Description of Component (A)

In the compositions used according to the invention, component (A) may be any type of organic thermoplastic elastomer having a hardness below 80 shore A measured at 23° C. according ISO 868.

All types of organic thermoplastic elastomer with the respective hardness value can be used. For instance, component (A) can be chosen from the thermoplastic materials cited in Norme ISO 18604:2003, for instance polyamide thermoplastic elastomers, comprising a block copolymer of alternating hard and soft segments with amide chemical linkages in the hard blocks and ether and/or ester linkages in the soft blocks, copolyester thermoplastic elastomers where the linkages in the main chain between the hard and soft segments are chemical linkages being ester and/or ether, olefinic thermoplastic elastomers consisting of a blend of polyolefin and conventional rubber, the rubber phase having little or no cross-linking, styrenic thermoplastic elastomers consisting of at least a triblock copolymer of styrene and a specific diene, where the two end-blocks are polystyrene and the internal block(s) are polydiene or hydrogenated polydiene, urethane thermoplastic elastomers having urethane chemical linkages in the hard blocks and ether, ester or carbonate linkages or mixtures of them in the soft blocks, thermoplastic rubber vulcanisate consisting of a blend of thermoplastic materials and a conventional rubber in which the rubber has been crosslinked by the process of dynamic vulcanisation during the blending and mixing step and mixtures of two or more of these. In particular, the styrene-based elastomers are the preferred ones, alongside thermoplastic polyurethane elastomers. The thermoplastic elastomers with the respective shore hardness values used in EP1060217, EP 1305367, EP1354003 and, in particular EP 1440122 in connection with the polyurethane materials, can be used.

For the avoidance of doubt hard blocks are so named because they have a glass transition point (tg) at a significantly higher temperature than the soft blocks. Typically the hard blocks will have a tg of >50° C. and preferably >80° C. and the soft blocks will have a tg<50° C. typically between −10 and 25° C.

Among organic thermoplastic elastomer having a hardness below 80 shore A measured at 23° C. according ISO 868, there are particularly preferred block copolymers having two or more hard blocks of aromatic vinyl units and one or more unsaturated, partially saturated, or fully saturated aliphatic soft blocks. Preferably, component (A) is a block copolymer having a numerical molecular weight between 30000 g/mol and 500000 g/mol composed of 2 or more hard blocks of aromatic vinyl units having a numerical molecular weight between 2000 g/mol and 70000 g/mol, and one or more unsaturated, partially saturated or fully saturated aliphatic soft blocks. The numerical molecular weight is measured using ASTM D5296-05 and is calculated as polystyrene molecular weight equivalents. Advantageously, the 2 or more hard blocks of aromatic vinyl units have a numerical molecular weight between 2000 g/mol and 70000 g/mol. The most common aromatic vinyl unit is styrene. So, component (A) is, preferably, a styrenic block copolymer having one or more unsaturated, partially saturated or fully saturated aliphatic soft blocks. Styrenic triblock copolymers are preferred.

Into the styrene block copolymers, the most used are the styrenic triblock copolymers known under a normalized nomenclature, as S(B)S, S(I)S, S(EB)S, S(EP)S, S(EEP)S, S(IB)S where S=Styrene, I=isoprene, B=butadiene, EB=ethylene-butylene, EP=ethylene-propylene, EEB=ethylene-ethylene-propylene, IS=isobutylene. The preparation of these block copolymers is well known by the man skilled in the art.

In this invention, styrene block copolymers exhibiting a primary peak of tg (delta) in the temperature range from −10° C. to 50° C. are preferred with high vinyl S(EP)S and S(IB)S are particularly preferred, because they exhibits a primary peak of tg(delta) higher than the others in the temperature range from 0° C. to 50° C. Advantageously, component (A) has its primary tg (delta) loss ratio not below 0.3 between 0° C. and 50° C. (measured dynamic rheometer (Metravib DMA 150) in tensile mode, frequency 10 HZ).

According to the invention, component (A) may be modified with a hydrocarbon resin miscible with the soft blocks. For instance, component (A) can be formulated with aromatic or aliphatic hydrocarbons resins as C9, C9 hydrogenated, C9 partially hydrogenated, C5, C5/C9 copolymers, terpenes, stabilized rosin ester, dicyclopentadiene (DCPD) hydrogenated to adjust its primary peak of tg(delta) toward the most suitable value and location in temperature for the application.

Apart from hydrocarbon resins, any ingredients used with these copolymers and known in the art, can be added to component (A). Among the ingredients are the plasticizers as those commonly used in the art, such as paraffinic or naphtenic organic oils, organic polymers as polyolefins, mineral fillers and an additive package.

### Description of Component (B)

In the compositions used according to the invention, component (B) can be a non cross-linked silicone or a cross-linked silicone. Nevertheless, component (B) is not a silicone polymer exhibiting dilatant properties in its own right, such as borated silicone polymers as described in WO 03/022085, WO 03/055339 or WO 2005/000966. In other words, the non cross-linked silicone used, for instance in the form of a gum or preparation of gum and silica, is pseudoplastic or shear thinning whereas dilatants are shear thickening. In other words, the dilatant material will flow in the absence of external force will be flexible and may even flow, whereas under the effect of impact, it will become temporarily rigid, returning to its flexible state after the impact.

The non cross-linked silicone of component (B) is a substantially non-reactive silicone with respect to component (A) in the absence of a cure package. By “non-reactive” it is meant that it does not react chemically (to form a covalent bond) with precursors of component A. However, preferably the same component (B) can be cross-linked in the presence of a suitable cross-linking package. Preferably the non cross-linked silicone, in the absence of a cross-linking package, is totally non-reactive, but small amounts of some reactivity can be tolerated, e.g. 0.001 to 2 percent. So, when the non cross-linked silicone is non-reactive the composition does not include a cross-linking package, such as a combination of polyorganohydrogensiloxane and hydrosilylation catalyst, as explained hereafter.

When it is a non cross-linked silicone, component (B) can be:
i) a silicone fluid with a Brookfield viscosity from 1,000 mPa·s to 3,000,000 of mPas at 25° C. (all viscosities, where possible, unless otherwise mentioned, are measured by Brookfield Rotational Viscometer, Model DVIII, Spindle CP52 at 0.5 rpm at 25° C.);
ii) a silicone gum with a molecular weight from 50,000 g/mol to 700,000 g/mol, or
iii) a silicone preparation as liquid silicone rubber (LSR) or high consistency rubber (HCR) with no cross-linker and catalyst.
   LSR and HCR are described in more detail below.

When it is cross-linked, component (B) can be formed from the reaction product of (a) a cross-linkable polydiorganosiloxane, (b) optionally a filler and (c) a cross-linking package. A cross-linkable polydiorganosiloxane polymer (a) has at least at least one alkenyl or alkynyl group per end group and optionally alkenyl or alkynyl groups linked to silicon atoms along the polymer backbone. For instance, component (B) can be obtained with i), ii), iii) previously described with the condition that i), ii), iii) contains polydiorganosiloxane alkenyl or alkynyl functional groups in the molecule. A preferred component (B) is a diorganopolysiloxane having a Williams plasticity of at least 30 as determined by ASTM test method 926 and having an average of at least 2 alkenyl radicals in its molecule. Indeed, when component (B) is cross-linked, cross-linking of i), ii), iii) is possible only with a cross-linking package (c) or cross-linking agent: advantageously, polyorganohydrogensiloxane and a hydrosilylation catalyst are added to i), ii), iii). Advantageously, the polyorganohydrogensiloxane contains at least three Si—H groups per molecule.

According to the invention, when component (B) is cross-linked, as it is preferred that component (A) and (B) would be intimately mixed, it is advantageous that cross-linking reaction of the silicone takes place during the hot mixing of component (A) and component (B). Such a process is called dynamic vulcanization and is reported in U.S. Pat. No. 6,013,715, included by reference. Preferably, the mixing and cross linking steps are conducted in a twin-screw extruder. Any suitable process may be utilised but typically component (A) is initially mixed with the polymer of component (B) until good inter-mixing is achieved. The cross-linker is then added followed by further mixing to disperse the cross-linker prior to the introduction of catalyst (if required).

Component (B) is present in the composition in an amount of from 5% to 70% by weight, based on the total weight of the composition. However preferably component (B) is present in an amount of at least 10% by weight, more preferably at least 15% by weight.

### Description LSR

In case component (B) is or is obtained with a liquid silicone rubber (LSR), such LSR can include a polyorganosiloxane polymer which comprises one or more polymers having the formula:

R_{(3-z)}R¹_{z}SiO[(R₂SiO)ₓ(RR¹SiO)_{y}]SiR_{(3-z)}R¹_{z}

wherein each R is the same or different and represents a C₁₋₆ alkyl group, an aryl (e.g. phenyl or naphthyl) group or a fluoro-C₁₋₆ alkyl group, preferably each R group is a methyl or ethyl group; R¹ is a C₂₋₆ alkenyl group or an alkynyl group, preferably a vinyl or hexenyl group; x is an integer and y is zero or an integer and x+y is a number (e.g. 100-1000) such that the polymer has a Brookfield viscosity at 25° C. of 50-250,000 mPas, preferably 100-100,000 mPas.

### Description HCR

In the case component (B) is or is obtained with a high consistency rubber (HCR), such HCR can include a polyorganosiloxane polymer which is based on the same formula but the starting Brookfield viscosity of the polymer is greater than 250,000 mPas at 25° C., more usually greater than 500,000 mPas at 25° C. and typically greater than 1,000,000 mPas at 25° C. The upper limit may be many millions. There is nothing preventing the use of a polydiorganosiloxane polymer with a Brookfield viscosity below 250,000 mPas at 25° C. in the present invention, but these would be an LSR rather than a HCR.

Because an HCR is usually in the form of a gum-like material which has such high Brookfield viscosity that the measurement of Brookfield viscosity is extremely difficult, HCRs are often referred by reference to their Williams plasticity number (ASTM D926). The Williams plasticity number of high viscosity polysiloxane gum-like polymers is generally at least 30, typically it is in the range of from about 30 to 250. The plasticity number, as used herein, is defined as the thickness in millimetres×100 of a cylindrical test specimen 2 cm³ in volume and approximately 10 mm in height after the specimen has been subjected to a compressive load of 49 Newtons for three minutes at 25° C. These polysiloxane gum-like polymers generally contain a substantially siloxane backbone (—Si—O—) to which are linked mainly alkyl groups such as for example methyl, ethyl, propyl, isopropyl and t-butyl groups, and some unsaturated groups for example alkenyl groups such as allyl, 1-propenyl, isopropenyl, or hexenyl groups but vinyl groups are particularly preferred and/or combinations of vinyl groups and hydroxyl groups to assist in their cross-linking. Such polysiloxane gum-like polymers typically have a degree of polymerisation (DP) of 500-20,000, which represents the number of repeating Si—O units in the polymer.

The HCR can be a polydiorganosiloxane (this form is particularly adapted for being cross-linked with a cross-linking package) in the form of a polymer or copolymer which contains at least 2 alkenyl radicals having 2 to 20 carbon atoms in its molecule. The alkenyl group is specifically exemplified by vinyl, allyl, butenyl, pentenyl, hexenyl and decenyl. The position of the alkenyl functionality is not critical and it may be bonded at the molecular chain terminals, in non-terminal positions on the molecular chain or at both positions. It is preferred that the alkenyl group is vinyl or hexenyl and that this group is present at a level of 0.001 to 3 weight percent, preferably 0.01 to 1 weight percent, in the polydiorganosiloxane gum.

The remaining (i.e., non-alkenyl) silicon-bonded organic groups in the polydiorganosiloxane are independently selected from hydrocarbon or halogenated hydrocarbon groups which contain no aliphatic unsaturation. These may be specifically exemplified by alkyl groups having 1 to 20 carbon atoms, such as methyl, ethyl, propyl, butyl, pentyl and hexyl; cycloalkyl groups, such as cyclohexyl and cycloheptyl; aryl groups having 6 to 12 carbon atoms, such as phenyl, tolyl and xylyl; aralkyl groups having 7 to 20 carbon atoms, such as benzyl and phenethyl; and halogenated alkyl groups having 1 to 20 carbon atoms, such as 3,3,3-trifluoropropyl and chloromethyl. It will be understood, of course, that these groups are selected such that the polydiorganosiloxane gum has a glass temperature (or melt point) which is below room temperature and the gum is therefore elastomeric. Methyl preferably makes up at least 85, more preferably at least 90, mole percent of the non-unsaturated silicon-bonded organic groups in the polydiorganosiloxane.

Thus, the polydiorganosiloxane can be a homopolymer, a copolymer or a terpolymer containing such organic groups. Examples include gums comprising dimethylsiloxy units and phenylmethylsiloxy units; dimethylsiloxy units and diphenylsiloxy units; and dimethylsiloxy units, diphenylsiloxy units and phenylmethylsiloxy units, among others. The molecular structure is also not critical and is exemplified by straight-chain and partially branched straight-chain, linear structures being preferred.

Specific illustrations of such polydiorganosiloxanes include: trimethylsiloxy-endblocked dimethylsiloxane-methylvinylsiloxane copolymers; trimethylsiloxy-endblocked methylphenylsiloxane-dimethylsiloxane-methylvinylsiloxane copolymers; dimethylvinylsiloxy-endblocked dimethylpolysiloxanes; dimethylvinylsiloxy-endblocked dimethylsiloxane-methylvinylsiloxane copolymers; dimethylvinylsiloxy-endblocked methylphenylpolysiloxanes; dimethylvinylsiloxy-endblocked methylphenylsiloxane-dimethylsiloxane-methylvinylsiloxane copolymers; and similar copolymers wherein at least one end group is dimethylhydroxysiloxy.

Component (iii) HCR may also consist of combinations of two or more polydiorganosiloxanes. Most preferably, component (iii) HCR is a polydimethylsiloxane homopolymer which is terminated with a vinyl group at each end of its molecule or is such a homopolymer which also contains at least one vinyl group along its main chain.

In an aspect of the present invention, the molecular weight of the polydiorganosiloxane gum is sufficient to impart a Williams plasticity number of at least about 30 as determined by the American Society for Testing and Materials (ASTM) test method 926.

Although there is no absolute upper limit on the plasticity of component (iii) HCR, practical considerations of processability in conventional mixing equipment generally restrict this value. Preferably, the plasticity number should be about 100 to 200, most preferably about 120 to 185.

Methods for preparing high consistency unsaturated group-containing polydiorganosiloxanes are well known and they do not require a detailed discussion in this specification. For example, a typical method for preparing an alkenyl-functional polymer comprises the base-catalyzed equilibration of cyclic and/or linear polydiorganosiloxanes in the presence of similar alkenyl-functional species.

### Cross-Linking of Component (B) by Hydrosilylation

Component (B) can be cross-linked. A cross-linked siloxane polymer can be obtained by reaction of a polydiorganosiloxane (i), (ii) or (iii) with a cross-linking package (c) consisting of a polyorganohydrogensiloxane (c1) and of a hydrosilylation reaction catalyst (c2). To effect cross-linking, the polyorganohydrogensiloxane (c1) must, where components (i), (ii) and/or (iii) contain no more than 2 alkenyl groups per molecule, contain more than two silicon-bonded hydrogen atoms per molecule, preferably 4-200 silicon-bonded hydrogen atoms per molecule, and most preferably 4-50 silicon-bonded hydrogen atoms per molecule. The polyorganohydrogensiloxane (c1) preferably has a Brookfield viscosity of up to about 10 000 mPas at 25° C., preferably up to 1000 mPa·s. The silicon-bonded organic groups present in the polyorganohydrogensiloxane (c1) can include substituted and unsubstituted alkyl groups of 1-4 carbon atoms that are otherwise free of ethylenic or acetylenic unsaturation. Preferably each polyorganohydrogensiloxane molecule comprises at least three silicon-bonded hydrogen atoms in an amount which is sufficient to give a molar ratio of Si—H groups in the polyorganohydrogensiloxane (c1) to the total amount of alkenyl or alkynyl groups in polymer of from 1:1 to 10:1.

Particularly preferred organohydrido silicon compounds (c1) are polymers or copolymers with RHSiO units ended with either R″₃SiO_{1/2} or HR″₂SiO_{1/2}, wherein R″ is independently selected from alkyl radicals having 1 to 20 carbon atoms, phenyl or trifluoropropyl, preferably methyl. It is also preferred that the viscosity of component (C) is about 0.5 to 1,000 MPa-s at 25° C., preferably 2 to 500 MPa·s. Further, this component preferably has 0.5 to 1.7 weight percent hydrogen bonded to silicon. It is highly preferred that component (c1) is selected from a polymer consisting essentially of methylhydridosiloxane units or a copolymer consisting essentially of dimethylsiloxane units and methylhydridosiloxane units, having 0.5 to 1.7 percent hydrogen bonded to silicon and having a viscosity of 2 to 500 MPa-s at 25 C. It is understood that such a highly preferred system will have terminal groups selected from trimethylsiloxy or dimethylhdridosiloxy groups.

Component (c1) may also be a combination of two or more of the above described systems. The organohydrido silicon compound (C) is used a level such that the molar ratio of SiH therein to Si-alkenyl in component (B) is greater than 1 and preferably below about 50, more preferably 3 to 20, most preferably 6 to 12.

These SiH-functional materials are well known in the art and many of them are commercially available.

Any suitable hydrosilylation catalyst (c2) may be utilised. Such hydrosilylation catalysts (c2) are known in the art and include any metal-containing catalyst which facilitates the reaction of silicon-bonded hydrogen atoms with the unsaturated hydrocarbon group, typically ruthenium, rhodium, palladium, osmium, iridium or platinum. Suitable hydrosilylation catalysts include chloroplatinic acid, alcohol-modified chloroplatinic acids, olefin complexes of chloroplatinic acid, complexes of chloroplatinic acid and divinyltetramethyldisiloxane, fine platinum particles adsorbed on carbon carriers, platinum supported on metal oxide carriers such as Pt(Al₂O₃), platinum black, platinum acetylacetonate, platinum(divinyltetramethyldisiloxane), platinous halides exemplified by PtCl₂, PtCl₄, Pt(CN)₂, complexes of platinous halides with unsaturated compounds exemplified by ethylene, propylene, and organovinylsiloxanes, styrene hexamethyldiplatinum. Such noble metal catalysts are described in U.S. Pat. No. 3,923,705 to show platinum catalysts. One preferred platinum catalyst is Karstedt's catalyst, a platinum divinyl tetramethyl disiloxane complex typically containing one weight percent of platinum in a solvent such as toluene which is described in U.S. Pat. No. 3,715,334 and U.S. Pat. No. 3,814,730. Another preferred platinum catalyst is a reaction product of chloroplatinic acid and an organosilicon compound containing terminal aliphatic unsaturation, see U.S. Pat. No. 3,419,593. Most preferred as the catalyst is a neutralised complex of platinous chloride and divinyl tetramethyl disiloxane, as described in U.S. Pat. No. 5,175,325.

Ruthenium catalysts such as RhCl₃(Bu₂S)₃ and ruthenium carbonyl compounds such as ruthenium 1,1,1-trifluoroacetylacetonate, ruthenium acetylacetonate and triruthenium dodecacarbonyl or a ruthenium 1,3-ketoenolate may alternatively be used. Other hydrosilylation catalysts suitable for use in the present invention include for example rhodium catalysts and suitable iridium catalysts

The catalyst may be added in an amount equivalent to as little as 0.001 part by weight of the metal per one million parts (ppm) of the composition (A)+(B). Preferably, the concentration of metal in the composition is that capable of providing the equivalent of at least 1 part per million of elemental metal. A catalyst concentration providing the equivalent of about 3-50 parts per million of elemental metal is generally the amount preferred.

Preferably, component (A) represents 25 to 60 weight percent of the total of components (A) and (b) through (c2).

### LSR or HCR with Fillers

LSR or HCR with fillers can be used as component (B). Any suitable filler or combination of fillers may be utilised. The elastomeric composition may contain one or more finely divided, reinforcing fillers, such as fumed or precipitated silica, and/or calcium carbonate, and/or non-reinforcing fillers, such as crushed quartz, diatomaceous earths, barium sulfate, iron oxide, titanium dioxide, carbon black, talc, and wollastonite. Other fillers which might be used alone or in addition to the above include aluminite, calcium sulfate (anhydrite), gypsum, calcium sulfate, magnesium carbonate, clays, e.g. kaolin, aluminium trihydroxide, magnesium hydroxide (brucite), graphite, copper carbonate, e.g. malachite, nickel carbonate, e.g. zarachite, barium carbonate, e.g. witherite and/or strontium carbonate e.g. strontianite, aluminium oxide, silicates selected from olivine group, garnet group, aluminosilicates, ring silicates, chain silicates and sheet silicates (the olivine group comprises silicate minerals, such as but not limited to, forsterite and Mg₂SiO₄; the garnet group comprises ground silicate minerals, such as but not limited to, pyrope, Mg₃Al₂Si₃O₁₂, grossular, and Ca₂Al₂Si₃O₁₂; aluninosilicates comprise ground silicate minerals, such as but not limited to, sillimanite, Al₂SiO₅, mullite, 3Al₂O₃.2SiO₂, kyanite, and Al₂SiO₅, the ring silicates group comprises silicate minerals, such as but not limited to, cordierite and Al₃(Mg,Fe)₂[Si₄AlO₁₈]; the chain silicates group comprises ground silicate minerals, such as but not limited to, wollastonite and Ca[SiO₃]; the sheet silicates group comprises silicate minerals, such as but not limited to, mica, K₂Al₁₄[Si₆Al₂O₂₀](OH)₄, pyrophyllite, Al₄[Si₈O₂₀](OH)₄, talc, Mg₆[Si₈O₂₀](OH)₄, serpentine for example, asbestos, Kaolinite, Al₄[Si₄O₁₀](OH)₈, and vermiculite) and silicone resins.

### Description of Filler Treatment

Fillers may be surface treated. A surface treatment of the filler(s) may be performed, for example with a fatty acid or a fatty acid ester such as a stearate, or with organosilanes, organosiloxanes, or organosilazanes hexaalkyl disilazane or short chain siloxane diols to render the filler(s) hydrophobic and therefore easier to handle and obtain a homogeneous mixture with the other components The surface treatment of the fillers makes them more easily wetted by the silicone polymer. These surface-modified fillers do not clump, and can be homogeneously incorporated into the silicone polymer. Furthermore, the surface-treated fillers give a lower conductivity than untreated or raw material.

Silanes found to be most suitable for the treatment of the fillers are alkoxysilanes of the general formula R²(₄₋ₙ)Si(OR²)ₙ, wherein n has a value of 1-3; and each R² is the same or different and represents a monovalent organic radical such as an alkyl group, an aryl group, or a functional group such as an alkenyl group, e.g. vinyl or allyl, an amino group or an amido group. Some suitable silanes therefore include alkyltrialkoxysilanes such as methyltriethoxysilane, methyltrimethoxysilane, phenyl tialkoxysilanes such as phenyltrimethoxysilane, or alkenyltrialkoxysilanes such as vinyltriethoxysilane, and vinyltrimethoxysilane. If desired, silazanes can also be used as treating agents for the mixture of aluminium trihydroxide and kaolin filler. These include, but are not restricted to, hexamethyldisilazane, 1,1,3,3-tetramethyldisilazane and 1,3-divinyltetramethyldisilazane. Short chain polydiorganosiloxanes might for example include hydroxy terminated polydimethylsiloxanes having a degree of polymerisation of from 2 to 20, hydroxy terminated polydialkyl alkylalkenylsiloxanes having a degree of polymerisation of from 2 to 20.

The proportion of such fillers when employed will depend on the properties desired in the elastomer-forming composition and the elastomer. Usually the filler content of the composition will reside within the range 5-500 parts by weight per 100 parts by weight of the polymer.

### Other Ingredients

Other ingredients which may be included in the compositions of the material include but are not restricted to co-catalysts for accelerating the cure of the composition such as metal salts of carboxylic acids and amines, rheological modifiers, adhesion promoters, pigments, colouring agents, desiccants, heat stabilizers, flame retardants, UV stabilisers, chain extenders, cure modifiers, electrically and/or heat-conductive fillers, blowing agents, anti-adhesive agents, handling agents, peroxide cure co-agents, acid acceptors, fungicides and/or biocides and the like (which may suitably by present in an amount of from 0 to 0.3% by weight), water scavengers, (typically the same compounds as those used as cross-linkers or silazanes). It will be appreciated that some of the additives are included in more than one list of additives. Such additives would then have the ability to function in each manner as stated.

Heat stabilizers may include antioxidants, UV absorbers, HALS for the main.

Flame retardants may include for example, carbon black, hydrated aluminium hydroxide, hydrated magnesium hydroxide and silicates such as wollastonite, and carbonates.

Electrically conductive fillers may include carbon black, metal particles such as silver particles any suitable, electrically conductive metal oxide fillers such as titanium oxide powder whose surface has been treated with tin and/or antimony, potassium titanate powder whose surface has been treated with tin and/or antimony, tin oxide whose surface has been treated with antimony, and zinc oxide whose surface has been treated with aluminium.

Thermally conductive fillers may include metal particles such as powders, flakes and colloidal silver, copper, nickel, platinum, gold aluminium and titanium, metal oxides, particularly aluminium oxide (Al₂O₃) and beryllium oxide (BeO), magnesium oxide, zinc oxide, zirconium oxide, ceramic fillers such as tungsten monocarbide, silicon carbide and aluminium nitride, boron nitride and diamond.

Optional diluents to be used with HCRs (and possibly with LSRs of higher viscosities) include aliphatics, namely white spirit, Stoddard solvent, hexane, heptane, c-hexane, and aromatics such as toluene and xylene.

### Description of a Non Cross-Linked and Non Reactive Silicone Fluid

Component (B) can be a non cross-linked and substantially non reactive silicone fluid. The non cross-linked and non reactive silicone fluid may be a polydiorganosiloxane described by the following formula:

R³₃SiO[(R³₂SiO)ₙ]SiR³₃

wherein each R³ is the same or different and represents C₁₋₁₈ alkyl (preferably C₁₋₈ alkyl and more preferably C₁₋₄ alkyl) or aryl (e.g. phenyl or naphthyl), either of which may optionally be further substituted with non-reactive groups, such as fluoro (e.g. a trifluoroalkyl group); preferably each R³ group is a methyl or ethyl group. It is typically a trialkyl silyl terminated polydimethylsiloxane (PDMS) fluid. Most preferably each terminal alkyl group is either methyl or ethyl but are not necessarily the same.

Alternatively, or in addition, the non-reactive silicone fluid may contain a polyorganosiloxane having a degree of branching due to the presence of one or more of either or both of the following groups in the R³₃SiO[(R³₂SiO)ₙ]SiR³₃ polymer backbone:

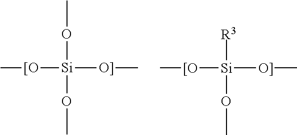

wherein R³ is as described hereinabove.

The value of n is such that the Brookfield viscosity of the polymer is 2,000-3,000,000 mPas, preferably 5,000-1,000,000 mPas, more preferably 10,000-500,000 mPas, at 25° C.

### Use and Moulded Articles

The invention concerns the use of all the compositions resulting in the combination of the above described component (A), (B) and other ingredients.

In accordance with the fundamental aspect of this invention, the above described compositions are used as an energy-absorbing material in order to provide impact resistance. Applications of such materials cover a wide range of uses and include impact protection for objects, animals and humans. Potential applications extend to any dynamic situation where the object may already be in contact with a surface and the combination of object and surface may undergo severe acceleration and/or deceleration, e.g. as in packaging for delicate equipment or a human body in a vehicle seat. Thus, the form of the material will be determined by the application.

In accordance of an aspect of the invention, the material can be obtained from thermoplastic pellets obtained by processing a mixture (A)+(B) or (A)+(a)+(b)+(c) described above into an extruder. In another aspect, the material is directly obtained in the form of a sheet or a moulded article with no pellet manufacturing step. The different components or precursors of the material may be moulded into any moulded shapes. For instance, the components or precursors of the material may be moulded into a sheet material using conventional one screw extruder and an appropriate die. Preferably, the sheet material has a thickness of 1-30 mm. The sheet material may be formed by reinforcing the above described composition of the material with fibres. Carbon, polyester, polyamide, polyaramide, polyolefin, polyimide, polyacrylonitrile, polyethylene tyerephtalate (PTFE), cotton, glass, silica fibers can be used.

The material used for impact protection, in the form of a sheet or a moulded article, can be foamed or unfoamed. In particular, the material can be foamed in closed cell foam as described in WO 2005/000966. When the composition is converted to a foamed sheet or foamed moulded article, it is possible to use any chemical or mechanical blowing agent used with thermoplastic materials. The sheet or article can be foamed with an addition of expandable hollow or plastic microspheres to the composition, during the conversion to the foamed sheet or foamed moulded article. According to another aspect, the foamed sheet or foamed moulded article can be fully cross-linked by a beam or by peroxides and suitable co agents added to the composition.

The material in the form of a sheet can be laminated to other sheets of the material or one or more alternative substrates, for instance by calandering or by the use of adhesives and/or welding techniques. Examples of such substrates are fabrics or non-woven materials. In particular, it may also be associated with a textile layer or similar where the textile has the facility to enhance the abrasion performance and in some cases the resistance to intrusion from sharp objects and/or assist in the attachment of the composite material to other systems or products. A stretchable textile backing will also serve to limit the elongation of the material and thereby provide durability. The textile may also serve as an antiballistic or stab-proof fabric such as certain woven grades of KEVLAR.

According to another aspect of the invention, the material can be used in the form of a laminate obtained by coextruded layers of thermoplastic materials including the material used according to the invention.

The sheet or laminate may also be in the form of a shaped article, for example so that it conforms to the contours of the human or animal body, e.g. knee, elbow or shoulder protection, or to form shaped packaging material. It may also be formed into a garment.

This may be achieved by, for example, thermoforming or overmoulding sheets. Sheets and/or laminates may additionally be embossed or otherwise marked, if required.

The composition may also be moulded into any mouldable shapes by injection moulding or compression moulding.

According to another aspect of the invention, the material can be in the form of fibers. The fibers may be woven, knitted or otherwise configured such as to incorporate air into the final article. When such a material is subjected to impact, the distortion of each fiber is facilitated by the air spaces to provide a large number of localized bending deflections, which is preferable for the efficient use of the composite material in absorbing impact.

According to the invention the energy absorbing material may be employed for the manufacture of articles in a wide variety of applications: for example in protective pads or clothing for humans and animals, in or as energy absorbing zones in vehicles and other objects with which humans or animals may come into violent contact, and in or as packaging for delicate objects or machinery. Specific examples of applications are in headwear and helmets, protective clothing or padding for elbows, knees, hips and shins; general body protection, for example for use in environments where flying or falling objects are a hazard, vehicle dashboards, suspension bushes, upholstery and seating. Other potential but not limited uses are in garments or padding to protect parts of the body used to strike an object e.g. in a sport or pastime; for example in running shoe soles, football boots, boxing gloves and gloves used in the playing of fives. The impact-resistant material may also be in the form of a shaped article, for example so that it conforms to the contours of the human or animal body, e.g. knee, elbow or shoulder protection. Examples e.g. for preventing/protecting the wearer from blunt trauma include (in each case as a separate protector or formed into a garment or included as part of a garment, elbow protectors, knee protectors, forearm protectors, thigh protectors, chest protectors, back protectors, shoulder, lower leg protectors and chest protectors shinguards, shin protectors, helmets, head protectors, hip protectors, gloves, kidney protection and coccyx protection. The impact-resistant material may also be in the form of footwear—e.g. heel of the shoe, forefoot, shoe upper or may be in protective sports equipment—e.g. rugby post protectors, training equipment, landing mats, cricket pads and gloves etc.

The protective equipment incorporating the impact-resistant material described in the present invention may be for contact sports, high risk sports and activities or the like such as, but not restricted to, rugby, soccer, American football, baseball, basketball, martial arts, boxing, sailing, windsurfing, wakeboarding, ice-skating, speedskating, snowboarding, skiing, ice-hockey, field hockey, roller hockey, roller blading, cricket, hurling, lacrosse, mountain biking, cycling, bobsleigh, extreme sports e.g. bungee jumping weightlifting and motorcycling.

The impact-resistant material may also be used in medical applications e.g. for hip protection, head protection for vulnerable people, protective devises to aid recovery from injury and/or orthopaedic devices or in work protection wear e.g. safety gloves, safety footwear, safety clothing.

Another application for the impact-resistant material is in the protection of items or articles into which the impact-resistant material may be incorporated or which may use the impact-resistant material as an encasement e.g. suitcases, laptop cases, laptop backpacks, camera cases, mobile phone cases, portable music equipment cases, golf clubs, surfboard protection, radio and in packaging for fragile items in transportation, lining of vehicles and crates for transportation. Furthermore, the impact-resistant material may be used in transportation applications such as automobile dashboards, bumpers, and safety equipment in other transport e.g. trains and aeroplanes.

In use a plurality of layers of the treated impact protection material may be utilised in order to suit the application for which it is to be used. The layers may be identical or may be a combination of alternative substrates described above or alternatively may be a combination one or more layers of impact protection material according to the present invention and layers of other materials. Furthermore, the composition described in the present invention may be applied alone to a substrate or may be applied with other suitable materials which do not negatively affect the impact resistance of the treated materials. Examples might include gels, resins and foams or the like.

The present invention will now be described with reference to the following examples, which are not intended to be limiting.

Unless otherwise indicated all viscosity values provided are in mPa·s and were measured at 25° C. and are Brookfield viscosity. 1 mPa·s is 0.1 Poise A poise is a cgs unit of viscosity equal to the tangential force in dynes per cm² required to maintain a difference in velocity of 1 cms⁻¹ between 2 parallel planes of a fluid separated by 1 cm. This is measured using a rotational flow method, which uses a rotating spindle immersed in the test liquid and measures torque and hence resistance to flow of the liquid. Typically measurements are taken using a Brookfield rotational viscometer, Model DVIII with a spindle CP52 at 0.5 rpm, measured at 25° C.

### EXAMPLE 1

In this example three compositions were prepared with component (B) not cross-linked:
component (A): a vinyl-bond rich SEPS with a styrene content=20% wt % and a hardness=64 shore A according to ISO 868 (Hybrar® 7125 from Kuraray) and
component (B): a HCR (polyvinyldimethylsiloxane) of plasticity from 60-65 MILS (SGM11 from Dow Corning)
   Compositions (quantities are given in parts by weight):

### Ex 1A: Hybrar® 7125/SGM 11 (85/15)

### Ex 1B: Hybrar® 7125/SGM 11 (70/30)

### Ex 1C: Hybrar® 7125/SGM 11 (60/40)

### EXAMPLE 2

In this example a further three compositions were prepared with component (B) not cross-linked:
component (A): a vinyl-bond rich SEPS with a styrene content=20% wt % and a hardness=64 shore A according ISO 868 (Hybrar® 7125 from Kuraray) and
component (B): a HCR containing 30% wt of silica of plasticity from 85-140 MILS (Silastic® HS71 from Dow Corning)
   Compositions (quantities are given in parts by weight):

### Ex 2A: Hybrar®7125/Silastic® HS71 (85/15)

### Ex 2B: Hybrar® 7125/Silastic® HS71 (70/30)

### Ex 2C: Hybrar® 7125/Silastic® HS71 (60/40)

In examples 1 and 2, the compositions are converted into pellets using a twin screw extruder of diameter=25 mm and L/D=48 and water batch cooling system equipped with a granulator.

Extruding conditions: screw speed=200 rpm/output=15 kg/h/melt temperature=180° C.

Pellets are moulded into 150 mm×150 mm×6 mm (L×I×e) plates using a Krauss Maffei injection moulding machine: moulding temperature: 180° C./mould temperature: 23° C.

### EXAMPLE 3

Six compositions containing a cross-linked silicone as component (B) are made with:

### Ex 3A: Hybrar® 7125/Silastic® HS-71 (60/40)

58.24 wt % of Hybrar® 7125
40 wt % of Silastic® HS71
1.2 wt % of Dow Corning® 7678 (a commercial cross-linker containing at least 3 Si—H bonds per molecule)
0.56 wt % Pt catalyst solution 10%

### Ex 3B: Hybrar® 7125/Silastie HS-71 (70/30)

68.54 wt % of Hybrar 7125
30 wt % of Silastic® HS71
0.9 wt % of Dow Corning® 7678 cross-linker
0.56 wt % Pt catalyst solution 10%

### Ex 3C: Hybrar® 7125/Silastic® HS-71 (85/15)

84.32 wt % of Hybrar® 7125
15 wt % of Silastic® HS71
0.45 wt % of Dow Corning® 7678 cross-linker
0.28 wt % Pt catalyst solution 10%

### Ex 3D: Hybrar® 7125/SGM 11 (60/40)

58.24 wt % of Hybrar® 7125
40 wt % of SGM 11
1.2 wt % of Dow Corning® 7678 cross-linker
0.56 wt % Pt catalyst solution 10%

### Ex 3E: Hybrar 7125/SGM 11 (70/30)

68.54 wt % of Hybrar® 7125
30 wt % of SGM 11
0.9 wt % of Dow Corning® 7678 cross-linker
0.56 wt % Pt catalyst solution 10%

### Ex 3F: Hybrar® 7125/SGM 11 (85/15)

84.32 wt % of Hybrar 7125
15 wt % of SGM 11
0.45 wt % of Dow Corning® 7678 cross-linker
0.28 wt % Pt catalyst solution 10%

In examples 3, the compositions are converted into pellets using a twin screw extruder of diameter=25 mm and L/D=48 (12 barrels) and water batch cooling system equipped with a granulator. Hybrar® 7125 and HCR (Silastic® HS-71 or SGM 11) are introduced respectively in barrel 1 and 2 and thoroughly mixed. The cross-linker is then introduced (on barrel 5) and thoroughly dispersed in the mixture introduced and finally, immediately before the commencement of cure catalyst is introduced through (barrel 8). Component (B) is then cured into the composition via a hydrosilylation cure.

Extruding conditions: screw speed=200 rpm/output=15 kg/h/melt temperature=180° C.

The resulting pellets can then be moulded into required shapes using a suitable press or the like. In the present example the resulting pellets are moulded in 150 mm×150 mm×6 mm (L×I×e) plates using a Krauss Maffei injection moulding machine.

In the event that a foam material is required, a foaming agent, such as by way of example EXPANCEL® 092 MB 120 from the company AKZO NOBEL, may be introduced.

Prepared sheets and foam sheets were then subjected to impact testing. Impact testing was carried out according to EN1621 Parts 1 and 2 “Motorcyclists' protective clothing against mechanical impact”, where a 5 kg weight of specified shape was caused to impact the device held over an anvil of specified shape, such that the impact energy is 50 J. A load cell within the anvil measures the resultant impact force transmitted through the device.

### Impact Test According to EN 1621-1

Sample=two 6 mm moulded plates
Impact energy=50J (5 kg/1m)
Temperature during the test=23° C.

| | Thick- | Peak |
|---|---|---|
| TPE + silicone | ness | force KN |
| Ex 1A: Hybrar ® 7125 + SGM11 (85/15) | 12 mm | 17.50 |
| Ex 1B: Hybrar ® 7125 + SGM11 (70/30) | 12 mm | 14.30 |
| Ex 1C: Hybrar ® 7125 + SGM11 (60/40) | 12 mm | 10.9 |
| Ex 2A: Hybrar ® 7125 + MF 370U (85/15) | 12 mm | 19.70 |
| Ex 2B: Hybrar ® 7125 + MF 370U (70/30) | 12 mm | 17.20 |
| Ex 2C: Hybrar ®7125 + MF 370U (60/40) | 12 mm | 15.20 |
| Ex 3A: Hybrar ® 7125 + SGM11 XL(85/15) | 12 mm | 16.00 |
| Ex 3B: Hybrar ® 7125 + SGM11 XL (70/30) | 12 mm | 13.80 |
| Ex 3C: Hybrar ® 7125 + SGM11 XL (60/40) | 12 mm | 12.00 |
| Ex 3D: Hybrar ® 7125 + MF 370U XL (85/15) | 12 mm | 19.70 |
| Ex 3E: Hybrar ® 7125 + MF 370U XL (70/30) | 12 mm | 16.90 |
| Ex 3F: Hybrar ® 7125 + MF 370U XL (60/40) | 12 mm | 14.40 |

Conservation of Performance after Repeated Impact

| | | Peak force | Peak force |
|---|---|---|---|
| | Thick- | KN (first | KN (fifth |
| TPE + silicone | ness | impact) | impact) |
| 1A: Hybrar ® 7125 + SGM11 (85/15) | 12 mm | 17.50 | |
| 1B: Hybrar ® 7125 + SGM11 (70/30) | 12 mm | 14.30 | |
| 1C: Hybrar ® 7125 + SGM11 (60/40) | 12 mm | 10.9 | 10.83 |
| 2A: Hybrar ® 7125 + MF 370U | 12 mm | 19.70 | |
| (85/15) | | | |
| 2B: Hybrar ® 7125 + MF 370U | 12 mm | 17.20 | |
| (70/30) | | | |
| 2C: Hybrar ® 7125 + MF 370U | 12 mm | 15.20 | 15.10 |
| (60/40) | | | |

To pass the EN 1621-1 the transmitted force on first impact must be below 35KN and as such it can be seen that each example clearly passes EN 1621-1.

### EXAMPLE 4

A composition containing
60% w % of Hybrar 7125
40% w % of a High Consistency Rubber of plasticity in the range 300-450 mm×10 according ASTM 926 (Silastic® NEW HS700 from Dow Corning)

Has been processed on a twin screw extruder in the same conditions than into the example no 2 to deliver pellets: The product in pellets form is named APS 24973 NAT

The pellets have been processed into sheets of 3 mm or 8 mm thickness. During the sheet extrusion process, a foaming agent as EXPANCEL® 092 MB 120 from the company AKZO NOBEL has been blended with APS 24973 NAT; The sheets have a density around 0.45.

The foamed 8 mm thick sheet id called TP8-002. In order to decrease the weight of the sheet some holes have been punctured to eliminate from 10% to 50% of weight

In the following table is the transmitted force in regards to the weight of the sheet.

| Testing conditions | Testing conditions |
|---|---|
| Norm EN 1621-1 | Norm EN 1621-2 |
| Temperature = 23° C. | Temperature = 23° C. |
| Impact energy = 50 J | Impact energy = 50 J |
| To pass the norm, transmitted force | To pass the norm, transmitted force |
| must be below 35 KN | must be below 18 KN for class 1 |

| TP8-002 | Transmitted force | Transmitted force |
|---|---|---|
| No holes | 16.1 KN | 15.6 KN |
| 10% weight reduction | 15.9 KN | 16.0 KN |
| 20% weight reduction | 16.1 KN | |
| 30% weight reduction | 16.7 KN | |
| 40% weight reduction | 17.0 KN | |
| 50% weight reduction | 17.4 KN | 17.6 KN |

As the transmitted force is independent of the weight by square meter of the sheet, we will preferred the lightest version that is more suitable for the most part of the applications. Hence all examples pass the norm, EN 1621-1. However, it is to be noted that the Examples also meet the requirement of transmitted force norm, must be below 18KN for class 1 and those tested meet such a requirement.

1. An impact-resistant material for the absorption of impact energy, the impact-resistant material comprising a mixture of, at least:
(a) component (A) an organic thermoplastic elastomer having a hardness below 80 shore A measured at 23° C. (ISO 868); and
(b) component (B) which is a non cross-linked and substantially non reactive silicone polymer or a cross-linked silicone polymer, with the exclusion of borated silicone polymers exhibiting dilatant properties, and component (B) is present in an amount of at least 15% by weight, based on the total weight of the material.

2. The impact-resistant material according to claim 1, wherein component (A) is a styrenic block copolymer having unsaturated, partially saturated, or fully saturated aliphatic soft blocks.

3. The impact-resistant material according to claim 1, wherein component (A) has its primary tg (delta) loss ratio not below 0.3 between 0° C. and 50° C.

4. The impact-resistant material according to claim 2, wherein component (A) is modified with a hydrocarbon resin miscible with the soft blocks.

5. The impact-resistant material according to claim 1, wherein component (A) is modified with an organic plasticizer.

6. The impact-resistant material according to claim 1, wherein component (B) is a silicone fluid with a viscosity from 1,000 mPa·s to 3,000,000 of mPas at 25° C.

7. The impact-resistant material according to claim 1, wherein component (B) is a silicone gum with a molecular weight from 50,000 g/mol to 700,000 g/mol.

8. The impact-resistant material according to claim 1, wherein component (B) is a high consistency rubber containing silica.

9. The impact-resistant material according to claim 1, wherein component (B) is present from 5% to 70% by weight, based on the total weight of the material.

10. The impact-resistant material according to claim 1, which is in the form of thermoplastic pellets.

11. The impact-resistant material according to claim 1, which is in the form of a sheet or any moulded article or a yarn.

12. The impact-resistant material according to claim 11, which is in the form of a foamed material.

13. The impact-resistant material according to claim 12, wherein the foamed material form is foamed by the addition of hollow microspheres that are added during the conversion to the foamed sheet or foamed moulded article.

14. The impact-resistant material according to claim 1, which is in the form of a sheet or foamed sheet laminated to one or more substrate.

15. The impact-resistant material according to claim 1, which is in the form of an article or a part of an article selected from protective pads, clothing for humans and animals, energy absorbing zones in vehicles, and packaging for delicate objects or machinery.

16. The impact-resistant material according to claim 1, wherein component (B) is the cross-linked silicone polymer.

17. The impact-resistant material according to claim 16, obtained by mixing component (A) and precursors of component (B): (a) a polydiorganosiloxane having a Williams plasticity of at least 30 as determined by ASTM test method 926 and having an average of at least 2 alkenyl radicals in its molecule, with (c1) an organohydrido silicon compound which contains an average of at least 2 silicon bonded hydrogen groups in its molecule, in the presence of (c2) a hydrosilation catalyst, and (b) optionally, a reinforcing filler, and by dynamically cross-linking component (B).

18-20. (canceled)

21. The impact-resistant material in accordance with claim 1, which is in the form of a sheet having a thickness of 1-30 mm.

22-29. (canceled)
